(19) United States
(12) Patent Application Publication
(10) Pub. No.: US 2020/0056704 A1
(43) Pub. Date: Feb. 20, 2020

(54) PISTON VALVE-SEALING STRUCTURE AND PISTON VALVE FLUID CONTROL METHOD

(71) Applicant: ROCKY-ICHIMARU CO., LTD., Chikugo-shi, Fukuoka (JP)

(72) Inventor: Hironobu ICHIMARU, Chikugo-shi (JP)

(73) Assignee: ROCKEY-ICHIMARU Co., Ltd., Chikugo-shi, Fukuoka (JP)

(21) Appl. No.: 16/340,075

(22) PCT Filed: Oct. 7, 2016
(86) PCT No.: PCT/JP2016/079913

§ 371 Date: Apr. 5, 2019

(51) Int. Cl. F16K 1/42; F16K 1/44

(52) U.S. Cl. CPC F16K 1/42; F16K 11/044; F16K 1/44

(57) ABSTRACT

A three-way valve of a piston valve seal structure includes a valve box, a valve stem, and a valve body. The valve stem is a metallic rod-shaped member that reciprocates up and down in a piston structure. In the valve body, an upper guide washer is provided on the valve stem adjacent to an upper disc ring. An outer diameter of a portion of the upper guide washer is slightly smaller than an inner diameter of a flat portion of a first valve seat. A lower guide washer is provided on the valve stem adjacent to a lower disc ring. An outer diameter of a portion of the lower guide washer is slightly smaller than an inner diameter of a flat portion of the second valve seat.

### TECHNICAL FIELD

The present disclosure relates to a piston valve seal structure and a fluid control method of a piston valve. More specifically, the present disclosure relates to a piston valve seal structure and a piston valve fluid control method capable of improving the durability of a valve body seal structure and enabling sufficient fluid control.

### BACKGROUND ART

Conventionally, a piston valve is used as a structure for controlling the flow of a fluid in piping or the like. In the piston valve, a stem attached to a piston serving as a driving mechanism reciprocates, and the valve body is operated in accordance with this movement.

In this piston valve, the valve body is configured to control the fluid by being in contact with the valve seat. For example, a globe valve in which the flows in an S-shape inside a globe-shaped valve box exists.

When controlling the flow of the fluid, a resinous seal part provided on a valve body is in close contact with a portion of a through hole provided in the valve seat in a liquid-tight manner. As a result, the through hole is closed at the seal part of the valve body, and thus the flow of the fluid is blocked or the route of the flow is changed.

For example, as a structure of a general globe valve, a globe valve described in Patent Document 1 exists.

Here, a valve body 100 illustrated in FIGS. 6 and 7 is described in Patent Document 1. The valve body 100 has a substantially Y-shaped valve box 101. In the valve box 101, a valve seat 104 is provided between flow paths consisting of a primary flow path 102 and a secondary flow path 103.

In addition, the valve body 100 has a stem 105 that is capable of reciprocating to and from the valve seat 104. The stem 105 includes a seal holder 107 equipped with a seal part 106 brought into/out of contact the valve seat 104 to close/open the flow path.

In the valve body 100, when the seal part 106 is brought into close contact with the valve seat 104 by the reciprocating motion of the stem 105, the flow path is in the closed state.

### PATENT DOCUMENT

### Patent Document 1: Japanese Patent Publication No. 2008-138847

### DETAILED DESCRIPTION OF THE INVENTION

### Technical Problem

Including the valve structure described in Patent Document 1, the conventional piston valves have a structure in which the end surface of the seal part is brought into plane contact with the end surface of the valve seat to achieve a seal. That is, the fluid flow is controlled by the plane contact in a direction orthogonal to the reciprocating direction of the stem.

Here, when the seal part approaches the valve seat, the flow path of the fluid flowing between the seal part and the valve seat is narrowed, and the flow speed of the fluid is increased, whereby a phenomenon in which the seal part is worn out occurs. The seal part is formed of a soft resin such as polytetrafluoroethylene in order to ensure liquid tightness, and as the flow of the fluid becomes fast at the time of sealing, the seal part is abraded by the fluid, and it becomes necessary to exchange the seal part in a short period of time.

The present disclosure has been made in consideration of the above points, and the present disclosure aims to provide a piston valve seal structure and a piston valve fluid control method that are capable of improving the durability of a valve body seal structure and performing sufficient fluid control.

### SUMMARY OF THE INVENTION

### Technical Solution

An object of the present invention is to provide a piston valve seal structure of the present disclosure comprising a valve box having an inlet and an outlet and having a fluid path through which the fluid flows in communication with the inlet and the outlet; a valve seat located on an inner peripheral surface of the valve box to block a fluid flow path and having therein a through hole serving as a fluid flow path; a stem formed in a rod shape and configured to be movable forwards and rearwards in a longitudinal direction thereof and through the through hole in the valve seat; a seal part provided on an outer peripheral surface of the stem and configured to come into close contact with the inner peripheral surface of the valve seat in a liquid-tight manner as the stem moves; and a flow rate control part formed at a position adjacent to the seal part of the stem and having an outer peripheral diameter slightly smaller than an inner peripheral diameter of the valve seat.

Here, by the valve box having the inlet and outlet and having a flow path through which a fluid flows in communication with the inlet and the outlet, it is possible to form a flow path of the piston valve that allows the fluid to flow therein. In addition, by connecting a piping path through which the fluid flows and the inlet and the outlet of the fluid, it is possible to dispose the piston valve in an existing piping facility.

By the valve seat located on the inner peripheral surface of the valve box to block the flow path of the fluid and having therein a through hole serving as a flow path of the fluid therein, it is possible to construct a partition structure for controlling or switching the flow of the fluid. That is, at the position of the valve seat, the fluid passes through the through hole portion, and by sealing the portion with a seal part to be described later, it is possible to prevent the fluid from passing through the through hole.

In addition, by a stem formed in a rod shape and capable of moving forwards and rearwards in the longitudinal direction thereof, it is possible to provide a structure moving inside the through hole in the valve seat. The moving-forward/rearward motion of the stem is implemented by a known piston-driving mechanism.

By the stem formed in the rod shape and configured to be movable forwards and rearwards in the longitudinal direction thereof and through the through hole in the valve seat, and the seal part installed on the outer peripheral surface of the step and configured to be in close contact with the inner peripheral surface of the stem in a liquid-tight manner, it is possible to bring the seal part into contact with the valve seat and to close the through hole.

By the flow rate control part formed at a position adjacent to the seal part of the stem and having an outer peripheral diameter slightly smaller than the inner peripheral diameter of the valve seat, it is possible to narrow the flow path between the valve seat and the stem. That is, before the valve seat and the seal part are brought into contact with each other, the flow path is narrowed between the flow rate control part and the valve seat, and as a result, the amount of fluid flowing through the flow path decreases. Thus, it is possible to reduce the damage caused to the seal part by the fluid just before the seal part is brought into contact with the valve seat.

When the difference between the inner peripheral diameter of the valve seat and the outer peripheral diameter of the flow rate control part is 0.25 mm or less in the cross section viewed from the short side direction of the stem, it is possible to further reduce the damage caused to the seal part just before the seal part is brought into contact with the valve seat.

Here, when the difference between the inner peripheral diameter of the valve seat and the outer peripheral diameter of the flow rate control part exceeds 0.25 mm in the cross section viewed in the short side direction of the stem, the flow path may be insufficiently narrowed, and the damage caused to the seal part by the fluid may not be reduced.

When the difference between the inner peripheral diameter of the valve seat and the outer peripheral diameter of the flow rate control part is 0.10 mm or less in the cross section viewed from the short side direction of the stem, it is possible to further reduce the damage caused to the seal part just before the seal part is brought into contact with the valve seat.

When at least a part of the inner peripheral surface of the valve seat and the outer peripheral surface of the flow rate control part is formed to be substantially flat in the vertical direction, the inner peripheral surface of the valve seat and the outer peripheral surface of the flow rate control part become close to each other, when the fluid flow path is narrowed, the fluid easily flows, and until the seal part comes into contact with the valve seat, it is possible to smoothen the flow.

Further, when a taper is formed in a portion of the seal part of the stem, which is in contact with the inner peripheral surface of the valve seat, in a cross section viewed in the short side direction of the stem, the fluid easily flows at the location of the seal part, and it is possible to reduce damage caused to the seal part by the fluid. The term “taper” referred to herein means a taper in a direction in which the diameter of the seal part increases from the flow rate control part side, in a cross section viewed in the short side direction of the stem.

Further, when the length of the flow rate control part in the vertical direction is within the range of 2.0 to 5.0 mm, it is possible to further reduce the damage caused to the seal part by the fluid just before the seal part is brought into contact with the valve seat.

Here, when the length of the flow rate control part in the vertical direction is less than 2.0 mm, the length in the vertical direction for narrowing the flow path becomes insufficient, and the damage caused to the seal part by the fluid may not be reduced. In addition, when the length of the flow rate control part in the vertical direction exceeds 5.0 mm, it becomes necessary to lengthen the stem, which may interfere with the design of the other structural members of the piston valve.

Further, when the length of the flow rate control part in the vertical direction is within the range of 3.0 to 4.5 mm, it is possible to further reduce the damage caused to the seal part by the fluid just before the seal part is brought into contact with the valve seat.

Further, the valve box may include multiple inlets and outlets; two valve seats including a first valve seat having therein a first through hole and a second valve seat having therein a second through hole may be provided along a moving direction of the stem; the seal part may include a first seal part configured to come into close contact with an inner peripheral surface of the first valve seat in a liquid-tight manner, and a second seal part located closer to an end side of the stem than the first seal part and configured to come into close contact with an inner peripheral surface of the second valve seat in a liquid-tight manner; and the flow rate control part may include a first flow rate control part located on a side opposite an end of the stem of the first seal part and a second flow rate control part located on a side of the end of the stem of the second seal part. Thereby, two closing parts configured to stop the flow of the fluid can be provided inside the piston valve. Thereby, a structure capable of switching multiple fluid paths is obtained. That is, for example, it is possible to provide a three-way valve structure having two fluid paths in one piston valve.

Further, in accordance with an aspect, the piston valve fluid control method includes the steps of: bringing, close to an inner peripheral surface of a valve seat formed inside a valve box, a flow rate control part of a stem having an outer peripheral diameter formed slightly smaller than an inner peripheral diameter of the inner peripheral surface to reduce a flow rate of a fluid; and bringing a seal part provided at a position adjacent to the flow rate control part of the stem into close contact with the inner peripheral surface of the valve seat in a liquid-tight manner to control a flow of the fluid.

Here, by the step of bringing, close to the inner peripheral surface of the valve seat formed inside the valve box, the flow rate control part of the stem having the outer peripheral diameter formed slightly smaller than the inner peripheral diameter of the inner peripheral surface, it is possible to reduce damage imparted to the seal part by the fluid just before the seal part is brought into contact with the valve seat.

In addition, by the step of bringing the seal part provided at the position adjacent to the flow rate control part of the stem into close contact with the inner peripheral surface of the valve seat in the liquid-tight manner to control the flow of the fluid, it is possible to stop the flow of the fluid at the position of the valve seat.

### Advantageous Effects

The piston valve seal structure according to the present disclosure improves the durability of the valve body seal structure and enables sufficient fluid control.

In addition, the piston valve fluid control method according to the present disclosure improves the durability of the valve body seal structure and enables sufficient fluid control.

### BRIEF DESCRIPTION OF THE DRAWINGS

These and other features, aspects and advantages of the present invention will become better understood with reference to the accompanying drawings, wherein:

FIG. 1 is a schematic view illustrating an exemplary piston valve seal structure to which the present disclosure is applied.

FIG. 2A is a schematic enlarged view illustrating the state in which a valve body seals an upper valve seat, and FIG. 2B is a schematic enlarged view illustrating the state in which the valve body seals a lower valve seat.

FIG. 3A is a schematic graph showing a relationship between an opening degree of a valve and a flow rate when using a piston valve seal structure to which the present disclosure is applied, and FIG. 3B is a schematic graph showing a relationship between an opening degree of a valve and a flow rate when a sealing structure of a conventional piston valve is used.

FIG. 4A is a schematic view illustrating the state in which the valve body seals the upper valve seat is, FIG. 4B is a schematic view illustrating the state in which the valve body is positioned near the upper valve seat, and FIG. 4C is a schematic view illustrating the state in which the valve body is positioned in the middle between the upper valve seat and the lower valve seat.

FIG. 5A is a schematic view illustrating the state in which the valve body is positioned near the lower valve seat and FIG. 5B is a schematic view illustrating the state in which the valve body seals the lower valve seat.

FIG. 6 is a schematic view illustrating the structure of the conventional piston valve.

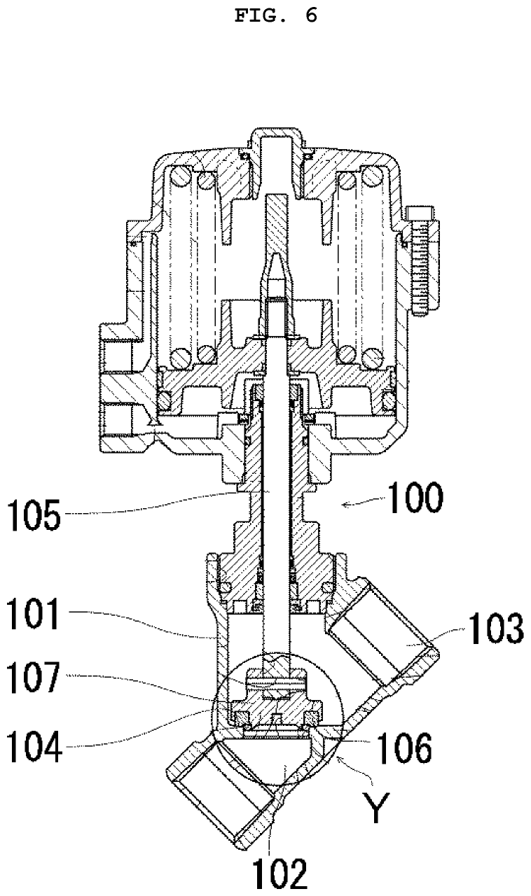

FIG. 7 is a schematic view illustrating the structure around the valve seat of the conventional piston valve.

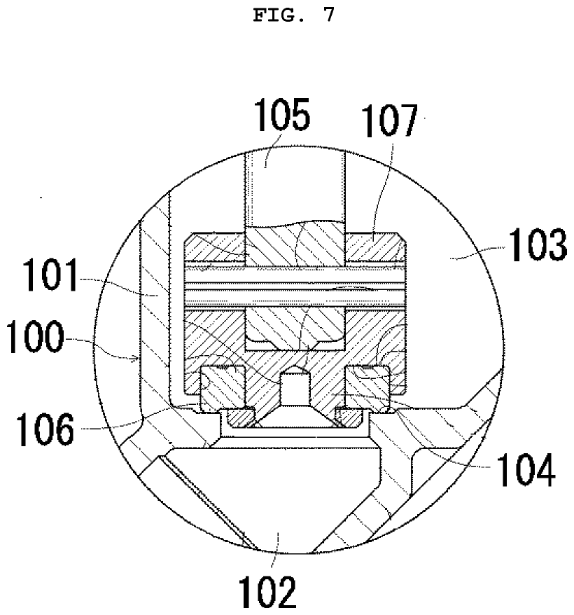

### DETAILED DESCRIPTION OF THE INVENTION

Hereinafter, embodiments of the present disclosure will be described with reference to the drawings to help the understanding of the present disclosure.

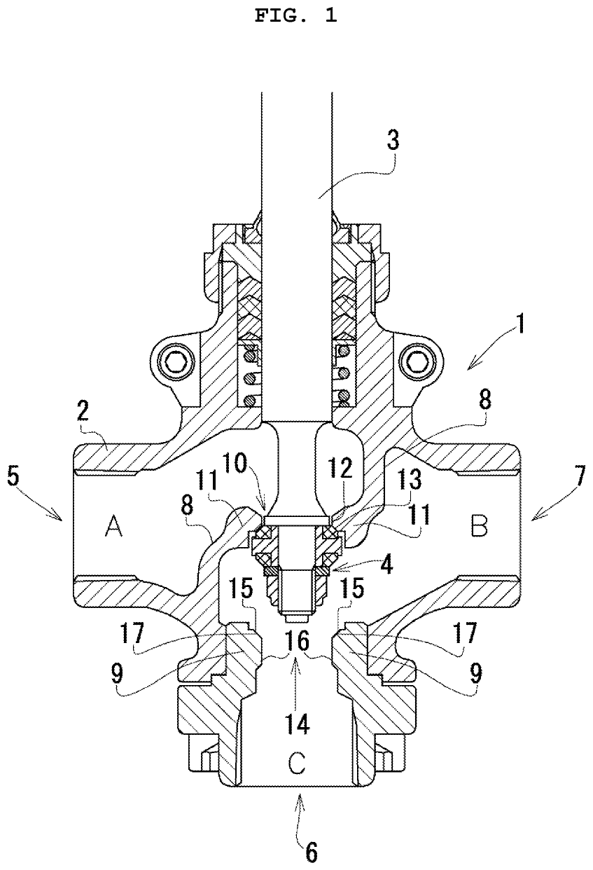

FIG. 1 is a schematic cross-sectional view illustrating an exemplary piston valve seal structure to which the present disclosure is applied. The structure illustrated below is an example of the present disclosure, and the contents of the present disclosure are not limited thereto.

As illustrated in FIG. 1, a three-way valve 1 according to an exemplary embodiment of a piston valve seal structure according to the present disclosure includes a valve box 2, a valve stem 3, and a valve body 4. The valve stem 3 is a metallic rod-shaped member that reciprocates up and down in a known piston structure (not illustrated).

The valve box 2 is a main body of the three-way valve 1 made of metal, and includes an inlet 5 formed at the left end, an outlet 6 formed at the lower end, and an inlet 7 formed at the right end. The inlets and outlet are connected to a predetermined piping structure and form a flow path inside the three-way valve 1.

In addition, in the valve box 2, a first partition 8 and a second partition 9 are formed so as to block the flow path of the fluid. The first partition 8 comes into contact with the valve body 4 to form a first fluid path (between reference numerals B and C) connecting the inlet 7 and the outlet 6. In addition, the second partition 8 comes into contact with the valve body 4 to form a second fluid path (between A and B) connecting the inlet 5 and the outlet 6.

The first partition 8 is formed substantially in the central portion of the valve box 1, and a first through hole 10 through which the valve stem 3 is insertable is formed at the center portion of the first partition 8. That is, in the valve box 1, the flow path of the fluid flowing in the inside of the valve box 1 is blocked by the first partition 8, and the first through hole 10 is closed by the valve body 4, whereby the flow of the fluid is controlled.

A first valve seat 11 is formed on the inner peripheral surface of the first partition 8 at the position where the first through hole 10 is formed. The first valve seat 11 is a portion that comes into contact with a disc ring (a part corresponding to the seal part in the claims of the present application) of the valve body 4 to be described later so as to perform sealing.

The first valve seat 11 includes a flat portion 12 formed substantially flat in the vertical direction and a tapered portion 13 formed continuously from the lower portion of the flat portion 12 in a vertical cross-sectional view.

The second partition 9 is formed in the vicinity of a lower outlet 6 of the valve box 1, and a second through hole 14 through which the valve stem 3 is insertable is formed in the center portion of the second partition 9. The above described first through hole 10 and second through hole are positioned along the axis line in the direction in which the valve stem 3 moves forwards and rearwards. In addition, in the valve box 1, the flow path of the fluid flowing in the inside of the valve box 1 is blocked by the second partition 9, and the second through hole 14 is closed by the valve body 4, whereby the flow of the fluid is controlled.

A second valve seat 15 is formed on the inner peripheral surface of the second partition 9 at the position where the second through hole 14 is formed. The second valve seat 15 is a portion that comes into contact with a disc ring (a part corresponding to the seal part in the claims of the present application) of the valve body 4 to be described later so as to perform sealing.

The second valve seat 15 includes a flat portion 16 formed substantially flat in the vertical direction and a tapered portion 17 formed continuously from the lower portion of the flat portion 16 in a vertical cross-sectional view.

The valve body 4 is a member provided on the side of the distal end portion of the valve stem 3, and is a member of controlling the flow of the fluid at the location of the first partition 8 or the second partition 9 by closing the first through hole 10 or the second through hole 14 described above.

More specifically, the valve body 4 is formed so as to be positioned between the first partition 8 and the second partition 9 as seen in the vertical direction in FIG. 1. The valve body 4 is brought into/out of contact with the first valve seat 11 or the second valve seat depending on the driving of the valve stem 3 in the vertical direction.

Here, the object that adopts the piston valve seal structure to which the present disclosure is applied is not necessarily the three-way valve 1, and any valve is applicable as long as it is a piston valve. For example, the valve may be a valve that has a structure with more branches of the flow path than a two-way valve or a three-way valve that controls the opening and closing of the flow path.

The combination of the flow paths of the three-way valve 1 is not necessarily limited, and the combination of the inlets and the outlets of the three-way valve 1 is merely an example.

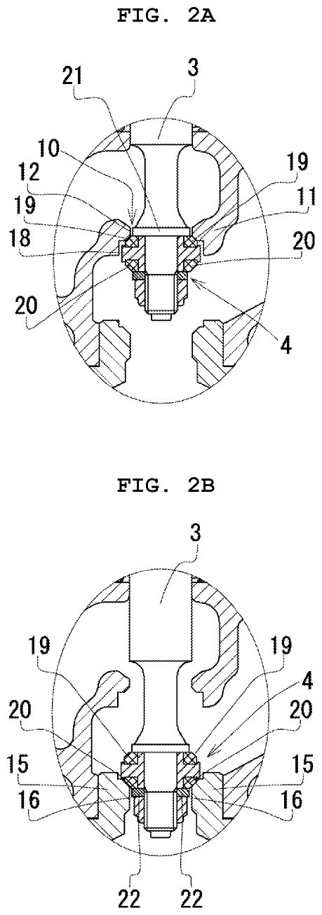

FIGS. 2A and 2B illustrate a detailed structure of the valve body 4. The valve body 4 includes a disc adapter 18 and an upper disc ring 19 and a lower disc ring 20 fitted on the upper and lower sides of the disc adapter 18. The valve stem 3 is positioned on the inner peripheral side of each member. The two disc rings are parts corresponding to the seal part of the claims of the present application and are formed of an elastic resin.

The upper disc ring 19 and the lower disc ring 20 are in close contact with the tapered portions of the first valve seat 11 and the second valve seat 15, respectively, in a liquid-tight manner. Since a disc ring is in close contact with each valve seat in a liquid-tight manner, the flow of fluid at the valve seat is controlled.

As illustrated in FIG. 2A, in the valve body 4, an upper guide washer 21 (corresponding to the fluid control part in the claims of the present application) is provided on the valve stem 3 adjacent to the upper disc ring 19. The outer diameter of the portion of the upper guide washer 21 is slightly smaller than the inner diameter of the flat portion 12 of the first valve seat 11.

More specifically, the difference between the inner diameter of the flat portion 12 and the outer diameter of the upper guide washer 21 can be 0.10 mm. The length of the upper guide washer 21 in the vertical direction can be 3.0 mm. When the valve stem 3 is driven and the valve body 4 closes the first valve seat 11, the upper guide washer 21 plays a role of reducing the flow rate of the fluid flowing through the first through hole 10.

When the flat portion 12 of the first valve seat 11 and the upper guide washer 21 come close to each other and are positioned substantially parallel to each other, the gap therebetween becomes small. Thus, the flow rate of the fluid is reduced, so that the effect of the fluid on the upper disc ring 19 can be reduced.

The upper guide washer 21 is a metal ring-shaped member and is fixed to the valve stem 3 with a screw.

As illustrated in FIG. 2B, a lower guide washer 22 (corresponding to the fluid control part in the claims of the present application) is provided on the valve stem 3 adjacent to the lower disc ring 20. The outer diameter of the portion of the lower guide washer 22 is slightly smaller than the inner diameter of the flat portion 16 of the second valve seat 15.

More specifically, the difference between the inner diameter of the flat portion 16 and the outer diameter of the lower guide washer 22 can be 0.10 mm. The length of the lower guide washer 22 in the vertical direction can be 3.0 mm. When the valve stem 3 is driven and the valve body 4 closes the second valve seat 15, the lower guide washer 22 plays the role of reducing the flow rate of the fluid flowing through the second through hole 14.

When the flat portion 16 of the second valve seat 15 and the lower guide washer 22 come close to each other and are positioned substantially parallel to each other, the gap therebetween becomes small. Thus, the flow rate of the fluid is reduced, so that the effect of the fluid on the lower disc ring 20 can be reduced.

The upper guide washer 21 and the lower guide washer 22 are metal ring-shaped members and are fixed to the valve stem 3 with screws.

Here, the guide washers are not necessarily formed separately from the valve stem to be provided on the valve stem. For example, a structure in which the valve stem and the guide washers are integrally formed may be adopted.

Further, the difference between the inner peripheral diameter of the flat portion of the valve seat and the outer peripheral diameter of the guide washer is not necessarily limited to 0.10 mm. For example, when it is desired to further reduce the flow rate of the fluid, the difference may have a numerical value of 0.10 mm or less.

From the viewpoint of reducing the influence on the disc ring by the flow of the fluid, it is desirable to set the difference between the inner peripheral diameter of the flat portion of the valve seat and the outer peripheral diameter of the guide washer to 0.25 mm or less. It is more desirable to set the difference to 0.10 mm or less. When the difference between the inner peripheral diameter of the flat portion of the valve seat and the outer peripheral diameter of the guide washer exceeds 0.25 mm, the throttling of the flow rate of the fluid becomes insufficient and the damage caused to the disc ring due to the flow of the fluid is difficult to reduce.

Here, the length of the guide washer in the vertical direction is not necessarily limited to 3.0 mm. For example, when it is desired to further reduce the flow rate of the fluid, the difference may have a numerical value of 3.0 mm or less.

In addition, from the viewpoint of making the size of the valve box 2 and the valve body 4 compact while sufficiently reducing the flow of the fluid, it is desirable to set the length of the guide washer in the vertical direction within the range of 2.0 to 5.0 mm. It is more desirable to set the length of the guide washer in the vertical direction within the range of 3.0 m to 4.5 mm. When the length of the guide washer in the vertical direction is less than 2.0 mm, the damage caused by the fluid to the seal part may not be reduced. In addition, when the length of the guide washer in the vertical direction exceeds 5.0 mm, it becomes necessary to lengthen the stem, which may disrupt the design of the other structural members of the piston valve.

The control of the flow rate of the fluid using the piston valve seal structure described above will be described below.

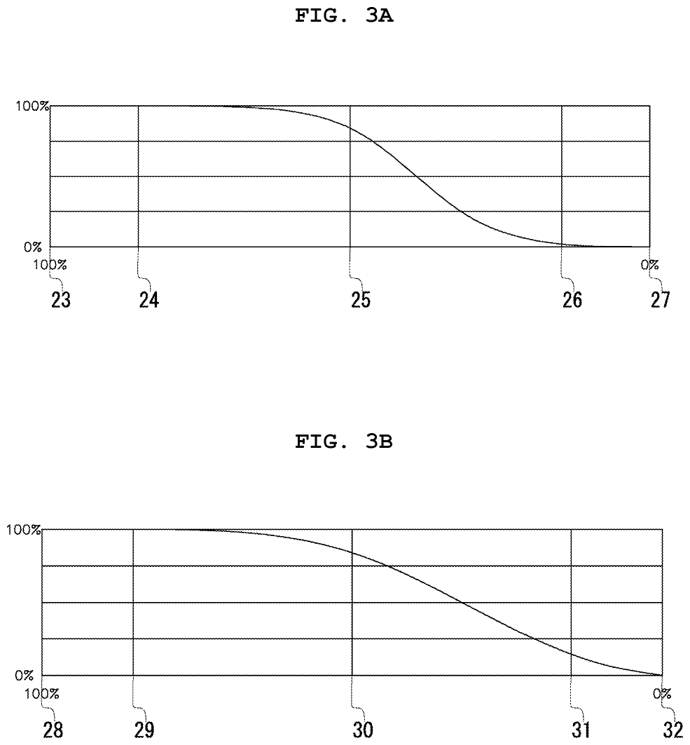

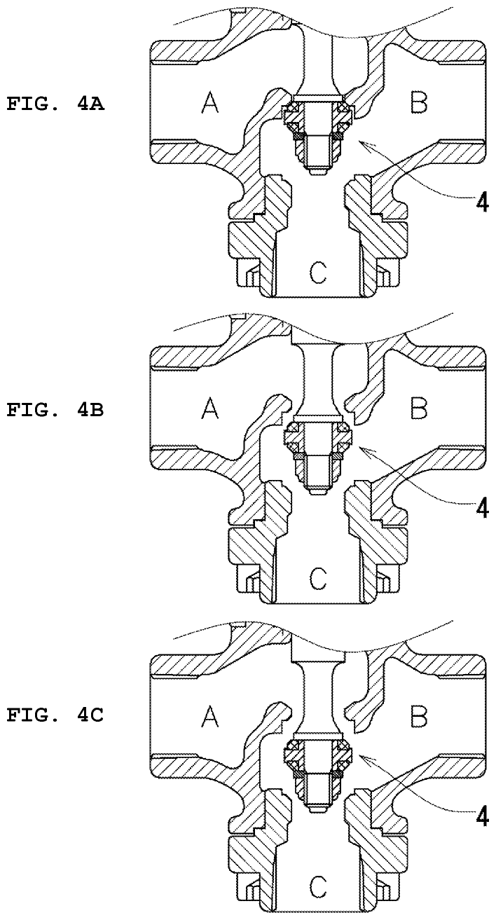

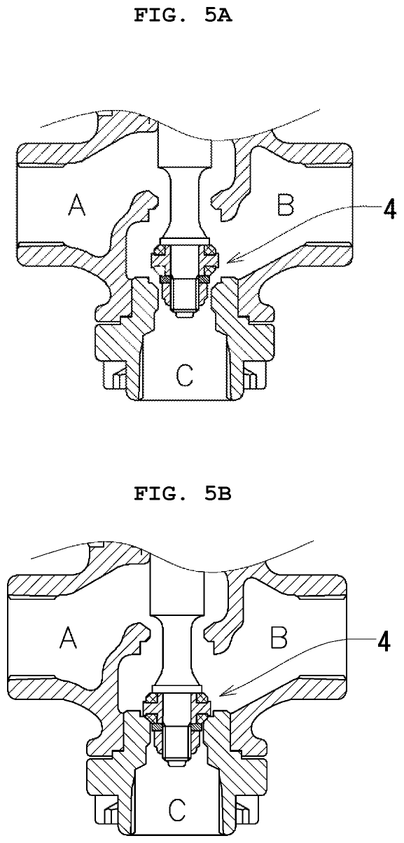

FIG. 3A is a schematic graph showing a relationship between an opening degree of a valve and a flow rate when using a piston valve seal structure to which the present disclosure is applied, and FIG. 3B is a schematic graph showing a relationship between an opening degree of a valve and a flow rate when a sealing structure of a conventional piston valve is used. FIG. 4A is a schematic view illustrating the state in which the valve body seals the upper valve seat, FIG. 4B is a schematic view illustrating the state in which the valve body is positioned near the upper valve seat, and FIG. 4C is a schematic view illustrating the state in which the valve body is positioned in the middle between the upper valve seat and the lower valve seat. FIG. 5A is a schematic view illustrating the state in which the valve body is positioned near the lower valve seat and FIG. 5B is a schematic view illustrating the state in which the valve body seals the lower valve seat.

FIGS. 3A and 3B are graphs schematically showing the flows of a fluid from the state in which the opening degree of the valve in the flow path of the fluid is 100% to the state in which the opening degree is 0% in the closed state. For example, the vertical axes in FIGS. 3A and 3B represent the ratio (%) of the flow rate of the fluid in the fluid flow from reference numeral B to reference numeral C (first fluid path), and the horizontal axes represent the ratio (%) of the opening degree of the valve body 4 with respect to the second valve seat 15 in the fluid flow from reference numeral B to reference numeral C (first fluid path).

In addition, reference numerals 23 to 27 in FIG. 3A indicate the states in which the valve body 4 is positioned as in FIGS. 4A to 4C, and FIGS. 5A and 5B, respectively. For example, when the valve body is located as in FIG. 4C, the position is indicated by reference numeral 25 in FIG. 3A, which is a conceptual view showing a relationship in which the flow rate of the fluid is about 80% of the flow rate at the opening degree of 100%.

Meanwhile, FIG. 3B is a graph schematically showing the flow rate when a fluid is similarly controlled by a conventional piston valve seal structure, which was not provided with a guide washer unlike the present disclosure. In addition, reference numerals 28 to 32 indicate the flow rates when the valve body is located as in FIGS. 4A to 4C, and FIGS. 5A and 5A, respectively, except that no guide washer is provided.

Upon comparing FIG. 3A and FIG. 3B, as indicated by reference numerals 25 and 30, at the stage where the opening degree of the second valve seat 15 is 50%, the flow rate ratios of the fluid are about the same as each other.

As shown in FIG. 3A, in the sealing structure of the piston valve to which the present disclosure is applied, from reference numerals 25 to 26, that is, until the valve body moves from the position in FIG. 4C to the position in FIG. 5A, the flow rate of the fluid remarkably decreases, and in the state in which the flow rate ratio is close to 0%, the valve body 4 is closed at the position of the second valve seat 15.

Meanwhile, as shown in FIG. 3B, in the conventional piston valve seal structure, the flow rate of 10% or more exists even at the point of reference numeral 31, and the flow rate ratio gradually approaches 0%. The difference between the two, in particular, the difference in the ratio of the fluid between reference numerals 26 and 27 and reference numerals 31 to 32 appears as a difference in damage caused by the flow speed of the fluid to the disc rings of the valve bodies.

This is caused by the fact that the driving of the piston valve and the moving speed themselves are not different in the structure to which the present disclosure is applied and the conventional structure and the valve seats are closed by the valve bodies at the same speed. That is, when the disc ring of the valve body approaches the valve seat without reducing the flow rate of the fluid, the disc ring of the valve body is greatly influenced by the flow of the fluid having the increased flow speed and is easily worn out. Meanwhile, in the piston valve seal structure to which the present disclosure is applied, since the gap between the guide washer and the valve seat is reduced earlier than the disc ring, and the flow rate of the fluid is reduced in this portion, it is possible to reduce damage to the disc ring even if the flow speed of the fluid increases.

As described above, the piston valve seal structure of the present disclosure improves the durability of the valve body seal structure and enables sufficient fluid control.

In addition, the piston valve fluid control method of the present disclosure improves the durability of the valve body seal structure and enables sufficient fluid control.

### DESCRIPTION OF REFERENCE NUMERALS

1: three-way valve

2: valve box

3: valve stem

4: valve body

5: inlet

6: outlet

7: inlet

8: first partition

9: second partition

10: first through hole

11: first valve seat

12: flat portion

13: tapered portion

14: second through hole

15: second valve seat

16: flat portion

17: tapered portion

18: disc adaptor

19: upper disc ring

20: lower disc ring

21: upper guide washer

22: lower guide washer

1. A piston valve seal structure comprising:
a valve box including an inlet and an outlet of a fluid, and a fluid flow path through which the fluid flows in communication with the inlet and the outlet;
a valve seat located on an inner peripheral surface of the valve box to block the fluid flow path wherein the valve seat includes a through-hole serving as the fluid flow path;
a stem formed in a rod shape and configured to be movable forwards and rearwards in a longitudinal direction thereof and through the through-hole in the valve seat;
a seal part provided on an outer peripheral surface of the stem and configured to come into contact with an inner peripheral surface of the valve seat in a liquid-tight manner as the stem moves; and
a flow rate control part formed adjacent to the seal part of the stem and having an outer peripheral diameter smaller than that of an inner peripheral diameter of the valve seat,
wherein the valve box includes multiple inlets and outlets,
wherein two valve seats including a first valve seat having therein a first through-hole and a second valve seat having therein a second through-hole are provided along a moving direction of the stem,
wherein the seal part includes a first seal part configured to come into contact with an inner peripheral surface of the first valve seat in a liquid-tight manner, and a second seal part located closer to an end side of the stem than the first seal part and configured to come into contact with an inner peripheral surface of the second valve seat in a liquid-tight manner, and
wherein the flow rate control part includes a first flow rate control part located on a side opposite an end of the stem of the first seal part and a second flow rate control part located on a side of the end of the stem of the second seal part.

2. The piston valve seal structure of claim 1, wherein a difference between the inner peripheral diameter of each of the valve seats and the outer peripheral diameter of the flow rate control part is 0.25 mm or less in a cross section viewed in a short side direction of the stem.

3. The piston valve seal structure of claim 2, wherein a difference between the inner peripheral diameter of each of the valve seats and the outer peripheral diameter of the flow rate control part is 0.10 mm or less in a cross section viewed in the short side direction of the stem.

4. The piston valve seal structure of claim 1, wherein at least a part of an the inner peripheral surface of each of the valve seats and an outer peripheral surface of the flow rate control part is formed substantially flat in a vertical direction.

5. The piston valve seal structure of claim 1, wherein the seal part includes a taper formed in a portion that is in contact with the inner peripheral surface of each of the valve seats in a cross section viewed in a short side direction of the stem.

6. The piston valve seal structure of claim 1, wherein a length of the flow rate control part, in a vertical direction, is within a range of 2.0 to 5.0 mm.

7. The piston valve seal structure of claim 6, wherein the length of the flow rate control part in the vertical direction is within a range of 3.0 to 4.5 mm.

8. (canceled)

9. (canceled)
